(19) United States
(12) Patent Application Publication
(10) Pub. No.: US 2019/0152266 A1
(43) Pub. Date: May 23, 2019

(54) PNEUMATIC TIRE

(71) Applicant: Toyo Tire & Rubber Co., Ltd., Itami-shi (JP)

(72) Inventor: Akinori Miyake, Itami-shi (JP)

(73) Assignee: Toyo Tire & Rubber Co., Ltd., Itami-shi (JP)

(21) Appl. No.: 16/180,389

(22) Filed: Nov. 5, 2018

(30) Foreign Application Priority Data
Nov. 20, 2017 (JP) 2017-223012

(51) Int. Cl. B60C 11/01

(52) U.S. Cl. CPC B60C 11/01; B60C 2011/013

(57) ABSTRACT

To provide a pneumatic tire capable of suppressing uneven wear occurring in the vicinity of a ground contact end of a tread portion. A pneumatic tire includes a tread portion, a side wall portion, a buttress portion provided between the tread portion and the side wall portion and a plurality of long holes provided in the buttress portion at intervals along a tire circumferential direction, in which the plural long holes are arranged so that a longitudinal direction thereof is inclined with respect to a tire radial direction and projections to the tire radial direction overlap with parts of the long holes adjacent to one another in the tire circumferential direction.

### BACKGROUND OF THE INVENTION

### 1. Field of the Invention

The present invention relates to a pneumatic tire.

### 2. Description of Related Art

In a pneumatic tire, a ground contact pressure is normally increased in the vicinity of a ground contact end of a tread portion during travelling. Therefore, uneven wear in which a wear amount in the vicinity of the ground contact end of the tread portion is larger than that in other parts may occur. As a method for suppressing the uneven wear, there is a method in which a plurality of small holes are provided in a buttress portion provided between the tread portion and a side wall portion at intervals along a tire circumferential direction in JP-A-5-294112 and JP-A-2002-29217. In this method, the ground contact pressure is reduced by reducing rigidity in the vicinity of the ground contact end of the tread portion to thereby suppressing occurrence of uneven wear.

In the tires disclosed in the above literatures, it is necessary to increase a cross-sectional area of each small hole to be provided in the buttress portion for obtaining higher reduction effect of the ground contact pressure. However, when the cross-sectional area of the small hole is increased, the volume of rubber contacting the ground in the vicinity of the ground contact end is largely reduced in the case where wear in the tread portion proceeds and small holes are exposed on a tread surface. Accordingly, there is a danger that the wear proceeds rapidly after the small holes are exposed.

### SUMMARY OF THE INVENTION

In view of the above, an object of the present invention is to provide a pneumatic tire capable of efficiently reducing rigidity in the vicinity of the ground contact end in the tread portion even when the cross-sectional area of small hole is small to thereby suppress uneven wear in the pneumatic tire provided with small holes in the buttress portion.

A pneumatic tire according to the present invention includes a tread portion, a side wall portion, a buttress portion provided between the tread portion and the side wall portion and a plurality of long holes provided in the buttress portion at intervals along a tire circumferential direction, in which the plural long holes are arranged so that a longitudinal direction thereof is inclined with respect to a tire radial direction and projections to the tire radial direction overlap with parts of the long holes adjacent to one another in the circumferential direction.

### BRIEF DESCRIPTION OF THE DRAWINGS

FIG. 1 is a perspective view showing a half section of a pneumatic tire according to a first embodiment of the present invention; and

FIG. 2 is a view showing small holes provided in the buttress portion.

### DESCRIPTION OF EMBODIMENTS

Hereinafter, an embodiment of the present invention will be explained with reference to the drawings.

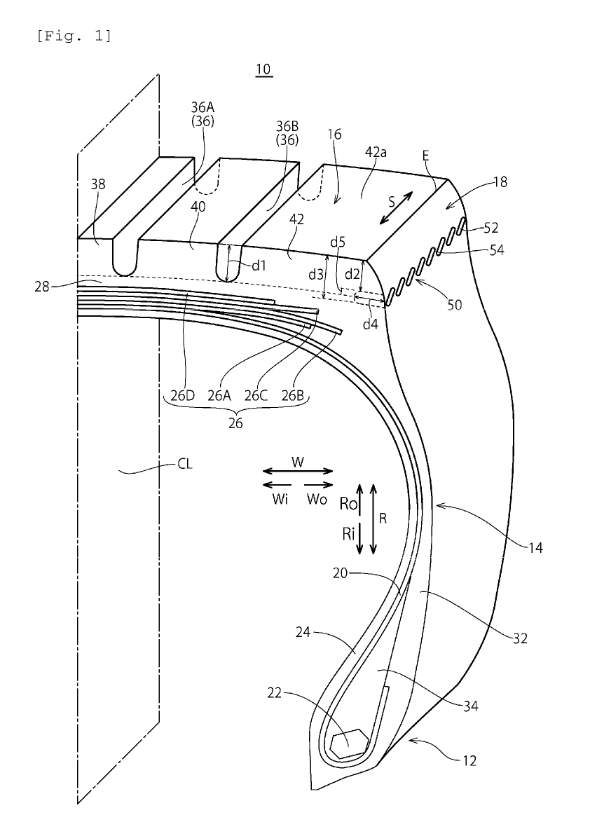

FIG. 1 is a perspective view showing a right-side half section of a pneumatic tire 10 according to the embodiment taken along a meridian section including a tire axis. As the pneumatic tire 10 is a symmetrical tire, a left-side half is not shown.

The pneumatic tire 10 shown in FIG. 1 includes a right and left pair of bead portions 12, a right and left pair of side wall portions 14 extending from the bead portions 12 outwardly in a radial direction, a tread portion 16 forming a tread surface and a right and left pair of buttress portions 18 arranged on a tire radial direction inner side of the tread portion 16. Here, the buttress portion 18 is a boundary region between the tread portion 16 and the side wall portion 14, which is provided so as to connect the tread portion 16 to the side wall portion 14.

The pneumatic tire 10 includes a carcass ply 20 provided to be stretched between the pair of bead portions 12 in a toroidal shape. In the pair of bead portions 12, ring-shaped bead cores 22 are respectively embedded.

The carcass ply 20 extends from the tread portion 16 to the bead portion 12 through the buttress portion 18 and the side wall portion 14 and locked by the bead core 22 at the bead portion 12, which reinforces the respective portions 12, 14, 16 and 18. The carcass ply 20 is locked by folding peripheral portions of the bead cores 22 from the inner side to the outer side in a tire width direction at both end portions in this example. An inner liner 24 for holding air pressure is arranged on an inner side of the carcass ply 20.

The carcass ply 20 is formed of at least one ply formed by arranging a cord made of organic fibers or steel so as to be inclined at a given angle (for example, 70° to 90°) with respect to a tire circumferential direction S and coated with topping rubber, and is formed by one ply in this example. As the organic fiber cord for forming the carcass ply 20, for example, cords made of polyester fiber, rayon fiber, aramid fiber, nylon fiber and the like are preferably used.

In the side wall portion 14, a side wall rubber 32 is provided on an outer side (namely, a tire outer surface side) of the carcass ply 20. In the bead portion 12, a bead filler 34 made of a rubber material extending toward a tire radial direction outer side in a tapered manner is arranged on an outer peripheral side of the bead core 22.

A belt 26 is arranged on the outer peripheral side of the carcass ply 20 in the tread portion 16. That is, the belt 26 is provided between the carcass ply 20 and a tread rubber 28 in the tread portion 16. The belt 26 is formed of plural pieces of cross belt plies arranged so that belt cords are inclined at a given angle (for example, 10° to 65°) with respect to the tire circumferential direction S. As the belt cord, a steel cord or an organic fiber cord having a high tensile force may be used.

The belt 26 has a four-layer structure including a first belt 26A positioned on the innermost side in a tire radial direction inner side Ri, a second belt 26B, a third belt 26C and a fourth belt 26D laminated in order on the outer peripheral side thereof, in which the second belt 26B is the maximum width belt having the widest width.

On the surface of the tread portion 16, plural pieces of main grooves 36 extending along the tire circumferential direction S are provided. Specifically, in a case of four grooves, the main grooves 36 include a pair of center main grooves 36A arranged on both sides with a tire equatorial plane CL interposed therebetween, and a pair of shoulder main groove 36B provided on a tire width direction outer side Wo of the pair of center main grooves 36A. The tire width direction outer side Wo indicates a side away from the tire equatorial plane CL in a tire width direction W.

According to the above four main grooves 36, a central land portion 38 is formed between the two center main grooves 36A, intermediate land portions 40 are formed between the center main grooves 36A and the shoulder main grooves 36B and shoulder land portions 42 are formed on the tire width direction outer side Wo of the two shoulder main grooves 36B in the tread portion 16.

In this example, the central land portion 38, the intermediate land portions 40 and the shoulder land portions 42 are formed by ribs continued in the tire circumferential direction S. The central land portion 38, the intermediate land portions 40 and the shoulder land portions 42 may be a block line separated in the tire circumferential direction S by lateral grooves.

An outer end in the tire width direction of a tread surface 42a in the shoulder land portion 42 forms a tread ground contact end E. The buttress portion 18 extending to the tire radial direction inner side Ri and forming an upper part of a tire side surface is connected to the tread ground contact end E.

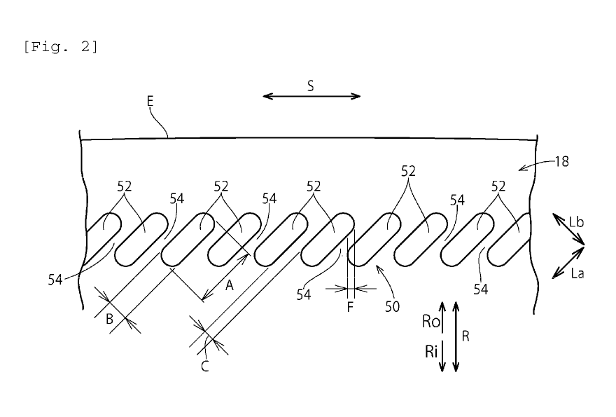

Then, in the buttress portion 18, a plurality of long holes 52 opening to an outer surface thereof are provided at intervals along the tire circumferential direction S as shown in FIG. 1 and FIG. 2.

The plural long holes 52 have the same shape, respectively. The long hole 52 is a recessed portion recessed almost toward a tire width direction inner side Wi, a cross-sectional shape (shape of an opening end opening to the outer surface of the buttress portion 18) of which is an elliptical shape in which short sides of a rectangle made to have an approximately half arc shape.

The plural long holes 52 are arranged so that a longitudinal direction La thereof is obliquely inclined with respect to a tire radial direction R. That is, the angle of the longitudinal direction La of the long hole 52 with respect to the tire radial direction R makes angles other than “0 (zero)” degree and 180 degrees. For example, an inclination angle of the long holes 52 in the longitudinal direction La with respect to the tire radial direction R may be set to 25 degrees or more to 65 degrees or less. The inclination angle of plural long holes 52 in the longitudinal direction La with respect to the tire radial direction R is set to be constant. Accordingly, the long holes 52 adjacent to one another in the tire circumferential direction are arranged in approximately parallel to one another. Moreover, the plural long holes 52 are arranged to be close to one another so that projections to the tire radial direction R overlap with parts F of long holes 52 adjacent in the tire circumferential direction S (see FIG. 2).

The plural long holes 52 form bridge portions 54 between long holes 52 adjacent with one another in the circumferential direction. That is, a long hole line 50 in which the long holes 52 and the bridge portions 54 are alternately aligned in the tire circumferential direction S is formed in the buttress portion 18. The bridge portions 54 connect portions on a tire radiation direction outer side Ro to portions on the tire radial direction inner side Ri in the plural long holes 52.

Positions where the above plural long holes 52 are provided are not particularly limited, however, a distance “d2” from the tread surface 42a of the shoulder land portion 42 to a tire diameter direction outer end of the long hole 52 can be set to 50% or more to 100% or less of a groove depth “d1” of the shoulder main groove 36B. Also, a distance “d3” from the tread surface 42a of the shoulder land portion 42 to a tire radial direction inner end of the long hole 52 can be set to be larger than the groove depth “d1” of the shoulder main groove 36B. That is, the tire radial direction inner end of the long holes 52 can be arranged farther on the tire radial direction inner side Ri than the groove bottom of the shoulder main groove 36B. It is also preferable that the long holes 52 are arranged farther on the tire radial direction outer side Ro than the belt 26.

Here, examples of respective dimensions of the long hole line 50 are cited with reference to FIG. 1 and FIG. 2. A length A of the long hole 52 in the longitudinal direction La may be set to 4 to 8 mm, a length B of the long hole 52 in a short side direction Lb is set to 1.5 to 3 mm, a depth “d4” of the long hole 52 is set to 5 to 10 mm, a width C of the bridge portion 54 may be set to 1 to 2 mm and a distance “d5” (=d1−d2) from a surface extended from the groove bottom of the shoulder main groove 36 to the tread surface in parallel to the tire radial direction outer end of the long hole 52 maybe set to 1 to 6 mm. The width C of the bridge portion 54 is preferably smaller than the length B of the short side direction La of the long hole 52.

The respective dimensions in the specification are in a normal state with no load in which the pneumatic tire is fitted to a normal rim and is filled with a normal internal pressure except for a case particularly mentioned. Also in the specification, the ground contact end indicates an end portion of the tread surface in the tire width direction contacting a road surface in a state where the pneumatic tire assembled to the normal rim and filled with the normal internal pressure is placed vertically on a flat road surface and a normal load is added.

The normal rim is a rim defined by respective standards for each tire in a standard system including standards to which the tire is conformed, which will be, for example, a standard rim in JATMA, “Design Rim” in TRA and “Measuring Rim” in ETRTO. The normal internal pressure is an air pressure defined by respective standards for each tire in the standard system including standards to which the tire is conformed, which will be, for example, the maximum air pressure in JATMA, the maximum value written in a table “TIRE LOAD LIMITS AT VARIOUS COLD INFLATION PRESSURES” in TRA, and “INFLATION PRESSURE” in ETRTO. The normal load is a load defined by respective standards for each tire in a standard system including standards to which the tire is conformed, which will be, for example, the maximum load ability in JTAMA, the maximum value written in the above table in TRA, and “LOAD CAPACITY” in ETRTO.

In the above pneumatic tire 10 according to the embodiment, the plural long holes 52 provided in the buttress portion 18 at intervals along the tire circumferential direction S are arranged so that the longitudinal direction La thereof is inclined with respect to the tire radial direction R and projections to the tire radial direction R overlap with parts of long holes 52 adjacent to one another in the tire circumferential direction S. Therefore, the bridge portions 54 with a relatively thin width inclined with respect to the tire radial direction R are formed between plural long holes 52. As such bridge portions 54 are easily deformed so as to fall down with respect to a load in the tire radial direction R, rigidity in the vicinity of the ground contact end E of the tread portion 16 can be efficiently reduced even when the cross-sectional area of the long holes 52 is small, which can suppress uneven wear.

Furthermore, when the width C of the bridge portions 54 is set to be smaller than the length B of the short side direction Lb of the long holes 52, the bridge portions 54 fall down more easily and the rigidity in the vicinity of the ground contact end E in the tread portion 16 can be reduced.

Also in the pneumatic tire 10 according to the embodiment, the tire radial direction inner end of the long hole 52 is positioned farther on the tire radial direction inner side Ri than the groove bottom of the shoulder main groove 36B, therefore, the effect of suppressing uneven wear by the long holes 52 can be obtained until an end stage of wear of tires.

The above embodiments are cited as examples and are not intended to limit the scope of the invention. The novel embodiments may be achieved in other various manners, and various kinds of omission, replacement and alterations may occur within a scope not departing from the gist of the invention.

What is claimed is:

1. A pneumatic tire comprising:
a tread portion;
a side wall portion;
a buttress portion provided between the tread portion and the side wall portion; and
a plurality of long holes provided in the buttress portion at intervals along a tire circumferential direction,
wherein the plural long holes are arranged so that a longitudinal direction thereof is inclined with respect to a tire radial direction and projections to the tire radial direction overlap with parts of the long holes adjacent to one another in the circumferential direction.

2. The pneumatic tire according to claim 1,
wherein the tread portion includes main grooves extending in the tire circumferential direction, and
a tire radial direction inner end of the long hole is positioned farther on a tire radial direction inner side than a groove bottom of the main groove.

3. The pneumatic tire according to claim 1,
wherein the buttress portion includes bridge portions formed between respective long holes adjacent in the tire circumferential direction, and
a width of the bridge portion is smaller than a length of a short side direction of the long hole.

4. The pneumatic tire according to claim 1,
wherein an inclination angle of the plural long holes in a longitudinal direction with respect to the tire radial direction is set to be constant.

5. The pneumatic tire according to claim 1,
wherein the inclination angle of the plural long holes in the longitudinal direction with respect to the tire radial direction is 25 degrees or more to 65 degrees or less.

6. The pneumatic tire according to claim 1,
wherein the tread portion includes a shoulder main groove and a shoulder land portion formed on a tire width direction outer side of the shoulder main groove, and
a distance from a tread surface of the shoulder land portion to a tire radial direction outer end of the long hole is 50% or more and 100% or less of a groove depth of the shoulder main groove.

7. The pneumatic tire according to claim 1, further comprising:
a belt provided in the tread portion,
wherein the long holes are arranged farther on a tire radial direction outer side than the belt.
